(19) United States
(12) Patent Application Publication
(10) Pub. No.: US 2011/0298728 A1
(43) Pub. Date: Dec. 8, 2011

(54) TOUCH PANEL

(75) Inventors: Woon Chun Kim, Gyunggi-do (KR); Yong Soo Oh, Gyunggi-do (KR); Jong Young Lee, Gyunggi-do (KR); Jae Il KIM, Yongin-si (KR)

(73) Assignee: SAMSUNG ELECTRO-MECHANICS CO., LTD., Gyeonggi-do (KR)

(21) Appl. No.: 12/880,986

(22) Filed: Sep. 13, 2010

(30) Foreign Application Priority Data
Jun. 7, 2010 (KR) 10-2010-0053465

(51) Int. Cl. G06F 3/041

(52) U.S. Cl. 345/173

(57) ABSTRACT

Disclosed herein is a touch panel 100 including: a transparent electrode 120 formed on one surface of a transparent substrate 110, a protective layer 130 formed at the side surface of the transparent electrode 120 so that its upper end 133 surrounds the edge of one surface of the transparent electrode 120 and its lower end 137 protrudes in the edge direction of the transparent substrate 110, and an electrode wiring 140 that is formed at the side surface of the protective layer 130 so as to surround the lower end 137 of the protective layer 130 protruding in the edge direction of the transparent substrate 110. The protective layer 130 is interposed between the transparent electrode 120 and the electrode wiring 140 to prevent the electromigration (EM).

### CROSS REFERENCE TO RELATED APPLICATION

This application claims the benefit of Korean Patent Application No. 10-2010-0053465, filed on Jun. 7, 2010, entitled “Touch panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting the computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device which is simple, does not malfunction, and has the capability to input easily is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used in a broad range of fields currently.

FIG. 1 is a cross-sectional view of a touch panel according to the prior art. Problems of the prior art will be described with reference to the figure.

As shown in FIG. 1, a touch panel 10 according to the prior art is configured to include a transparent electrode 13 formed on a transparent substrate 11 to sense the touch of an input unit, and an electrode wiring 15 formed on both ends of the transparent electrode 13 to transfer an electrical signal between the transparent electrode 13 and a controller. Herein, the transparent electrode 13 is generally made of indium tin oxide (ITO), whereas the electrode wiring 15 is made of silver (Ag). Therefore, an electromigration (EM) phenomenon occurs, the electromigration (EM) phenomenon that electrons move due to potential difference between the transparent electrode 13 and the electrode wiring 15 when current flows. Reviewing the electromigration (EM) phenomenon in detail, when current flows on the first transparent electrode 13, numerous electrons move from a cathode to an anode and the electrons collide with metal atoms forming the transparent electrode 13, such that a momentum exchange is generated. Voids due to the exhaustion of atoms are formed in the cathode by the momentum exchange to cause a disconnection and a hillock due to the accumulation of atoms are generated in the anode to cause a disconnection, such that the transparent electrode 13 is modified.

In addition, the touch panel 10 according to the prior art has a structure in which the electrode wiring 15 is formed on the upper part of the transparent electrode 13, such that the thickness of the entire touch panel 10 becomes thick and thus it is difficult to make the touch panel 10 thin.

### SUMMARY OF THE INVENTION

The present invention has been made in an effort to provide a touch panel that can prevent electromigration (EM) between a transparent electrode and an electrode wiring by adopting a protective layer and make it thin by disposing the electrode wiring at the side surface of the transparent electrode rather than on the upper part of the transparent electrode.

A touch panel according to a preferred embodiment of the present invention includes: a transparent electrode formed on one surface of a transparent substrate; a protective layer formed at the side surface of the transparent electrode so that its upper end surrounds the edge of one surface of the transparent electrode and its lower end protrudes in the edge direction of the transparent substrate; and an electrode wiring that is formed at the side surface of the protective layer so as to surround the lower end of the protective layer protruding in the edge direction of the transparent substrate.

Herein, the protective layer is made of gold (Au), platinum (Pt), carbons, or a mixture thereof.

Further, the carbons include a carbon nano tube or a carbon nano fiber.

Further, the transparent electrode is made of a conductive polymer.

Further, the conductive polymer includes poly-3,4-ethylenedioxythiophene/polystyrenesulfonate (PEDOT/PSS), polyaniline, polyacetylene, or polyphenylenevinylene.

Further, the height of the lower end of the protective layer protruding in the edge direction of the transparent substrate is lower than the height of the transparent electrode.

### BRIEF DESCRIPTION OF THE DRAWINGS

FIG. 1 is a cross-sectional view of a touch panel according to the prior art;

FIG. 2 is a cross-sectional view of a touch panel according to a preferred embodiment of the present invention;

FIG. 3 is a perspective view of the touch panel of FIG. 2; and

FIGS. 4 to 6 are cross-sectional views of a touch panel according to another preferred embodiment of the present invention.

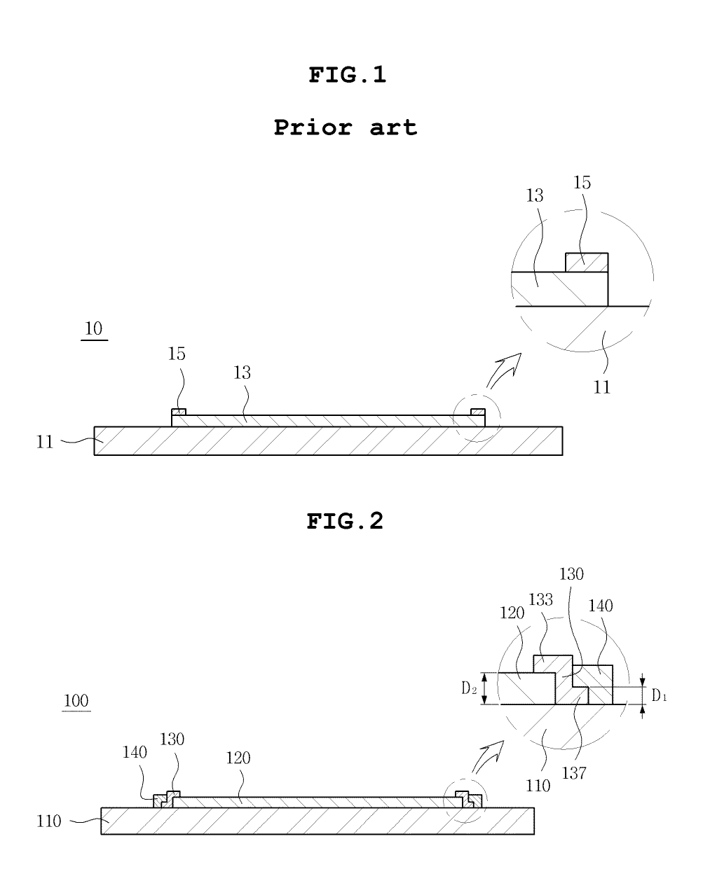

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the gist of the present invention.

Hereinafter, preferred embodiments of the present invention will be described in detail with reference to the accompanying drawings.

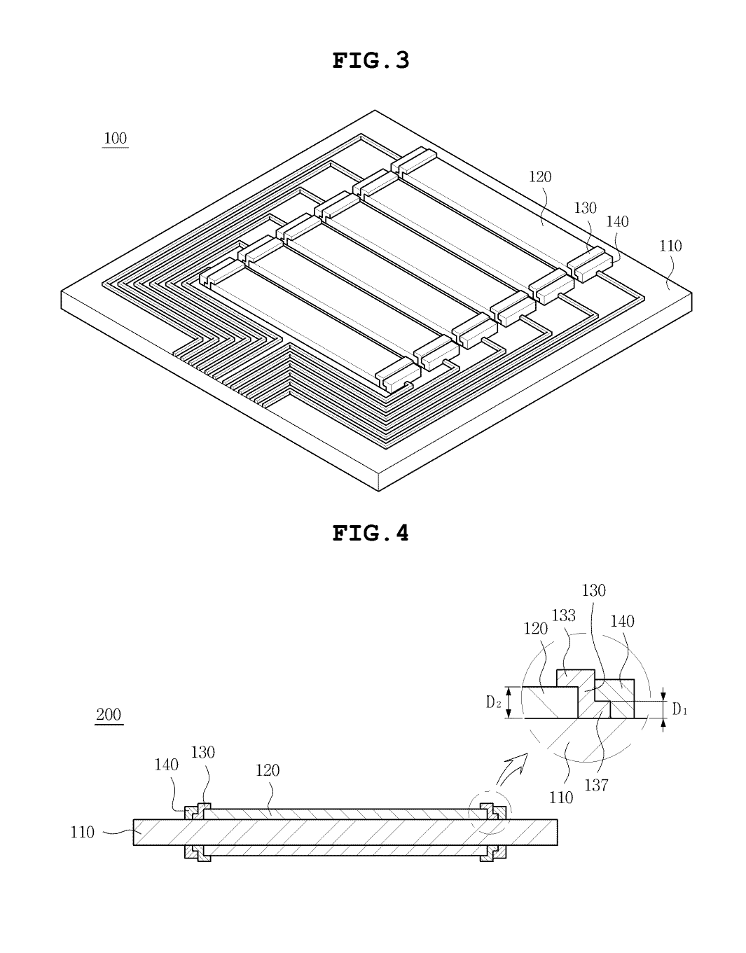

FIG. 2 is a cross-sectional view of a touch panel according to a preferred embodiment of the present invention, and FIG. 3 is a perspective view of the touch panel of FIG. 2.

As shown in FIGS. 2 and 3, a touch panel 100 according to the present embodiment is configured to include a transparent electrode 120 formed on one surface of a transparent substrate 110, a protective layer 130 formed at the side surface of the transparent electrode 120 so that its upper end 133 surrounds the edge of one surface of the transparent electrode 120 and its lower end 137 protrudes in the edge direction of the transparent substrate 110, and an electrode wiring 140 formed at the side surface of the protective layer 130 so as to surround the lower end 137 of the protective layer 130 protruding in the edge direction of the transparent substrate 110.

The transparent substrate 110 is partitioned into an active region and a bezel region, wherein the active region, a portion on which the transparent electrode 120 is formed in order to recognize a user's touch, is provided on the center of the transparent substrate 110, and the bezel region, a portion on which the protective layer 130 and the electrode wiring 140 conductive with the transparent electrode 120 are formed, is provided at the edge of the transparent substrate 110. Herein, the material of the transparent substrate 110 is not particularly limited, and may include polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass or tempered glass and so on.

The transparent electrode 120 serves to generate signals when a user touches the panel and allow a controller to recognize touched coordinates. The transparent electrode is formed in the active region of the transparent substrate 110. Herein, the transparent electrode 120 may include a conductive polymer having excellent flexibility and a simple coating process as well as indium tin oxide (ITO) that is commonly used. At this time, the conductive polymer includes poly-3,4-ethylenedioxythiophene/polystyrenesulfonate (PEDOT/PSS), polyaniline, polyacetylene, polyphenylenevinylene, or the like. Meanwhile, it is preferable that a high frequency process or a primer process is performed on the transparent substrate 110 in order to activate the surface thereof (improve adhesion) before forming the transparent electrode 120 on one surface of the transparent substrate 110. In addition even though the transparent electrode 120 is shown to be a bar type (see FIG. 3), it is just exemplary and the transparent electrode 120 is not always limited to the bar type but may also be formed to be a diamond shape, a triangular type, an octagonal type, or a circular type.

The protective layer 130, which serves to prevent electromigration (EM) between the transparent electrode 120 and the electrode wiring 140, is formed at the side surface of the transparent electrode 120. More specifically, the upper end 133 of the protective layer 130 surrounds the edge of one surface of the transparent electrode 120 to be conductive with the transparent electrode 120, and the lower end 137 of the protective layer 130 protrudes in the edge direction of the transparent substrate 110 to be conductive with the electrode wiring 140. In other words, the protective layer 130 is formed to have a “ [symbol] ” shape to widen the contact area with the transparent electrode 120 and the electrode wiring 140, thereby making it possible to enhance structural stability and reliability, and to prevent the edge of the transparent electrode 120 from being exposed to the external environment, thereby making it possible to protect the transparent electrode 120. In addition, the protective layer 130 is preferably made of a material having high electromigration resistance in order to prevent the electromigration between the transparent electrode 120 and the electrode wiring 140. The material of the protective layer 130 is not specifically limited but may preferably be made of gold (Au), platinum (Pt), carbons, or a mixture thereof. At this time, the carbons include carbon nano tube (CNT) or carbon nano fiber (CNF). Herein, the protective layer 130 may be manufactured in a paste shape to be printed.

Meanwhile, when the transparent electrode 120 is made of a conductive polymer including poly-3,4-ethylenedioxythiophene/polystyrenesulfonate (PEDOT/PSS), polyaniline, polyacetylene, polyphenylenevinylene, or the like, if the transparent electrode 120 directly contacts the electrode wiring 140, an insulating compound is also generated in addition to the electromigration. However, the protective layer 130 is interposed between the transparent electrode 120 and the electrode wiring 140, thereby making it possible to prevent the insulating compound from being generated.

In addition, the touch panel 100 according to the present embodiment adopts the protective layer 130 to allow the electrode wiring 140 to be disposed at the side surface of the transparent electrode 120 rather than on the upper part of the transparent electrode 120, thereby making it possible to make the touch panel 100 thin. Herein, in order to more effectively make the touch panel 100 thin, it is preferable that the height D1 of the lower end 137 of the protective layer 130 protruding in the edge direction of the transparent substrate 110 is lower than the height D2 of the transparent electrode 120.

The electrode wiring 140, which serves to transfer the electrical signal between the transparent electrode 120 and the controller, is formed at the side surface of the protective layer 130. More specifically, the electrode wiring 140 surrounds the lower end 137 of the protective layer 130 protruding in the edge direction of the transparent substrate 110 to be conductive with the protective layer 130 and subsequently, to be conductive with the transparent electrode 120 through the projective layer 130. In other words, the electrode wiring 140 is formed to have a “ [symbol] ” shape to widen the contact area with the protective layer 130, thereby making it possible to enhance structural stability and reliability. Meanwhile, the electrode wiring 140 may be formed using a silk screen method, a gravure printing method, an ink-jet printing method or the like. Further, the electrode wiring 140 may be made of silver (Ag) paste or organic Ag having superior electrical conductivity, but the present invention is not limited thereto. In addition, a conductive polymer, carbon black (including CNT), or a low resistive metal including metal or a metal oxide such as ITO may be used. Meanwhile, although the electrode wirings 140 are shown to be connected to both ends of the transparent electrode 120, it is exemplary (see FIG. 3) and they may also be connected to only one end of the transparent electrode 120 according to the type of the touch panel 100. At this time, the protective layer 130 may also be connected to only one end of the transparent electrode 120 to which the electrode wiring 140 is connected.

Meanwhile, in order to prevent the transparent electrode 120, the protective layer 130, and the electrode wiring 140 from being damaged from external environments, an adhesive layer may be formed on one surface of the transparent substrate 110 in order to coat the transparent electrode 120, the protective layer 130, and the electrode wiring 140, wherein a window panel receiving a user's touch may be bonded to the adhesive layer.

As described above, the touch panel 100 according to the present embodiment may be manufactured as not only a self capacitive touch panel 100 or a mutual capacitive touch panel 100 using the transparent electrode 120 with a single layer structure but also various types of touch panels including the configuration as described below.

FIGS. 4 to 6 are cross-sectional views of a touch panel according to another preferred embodiment of the present invention.

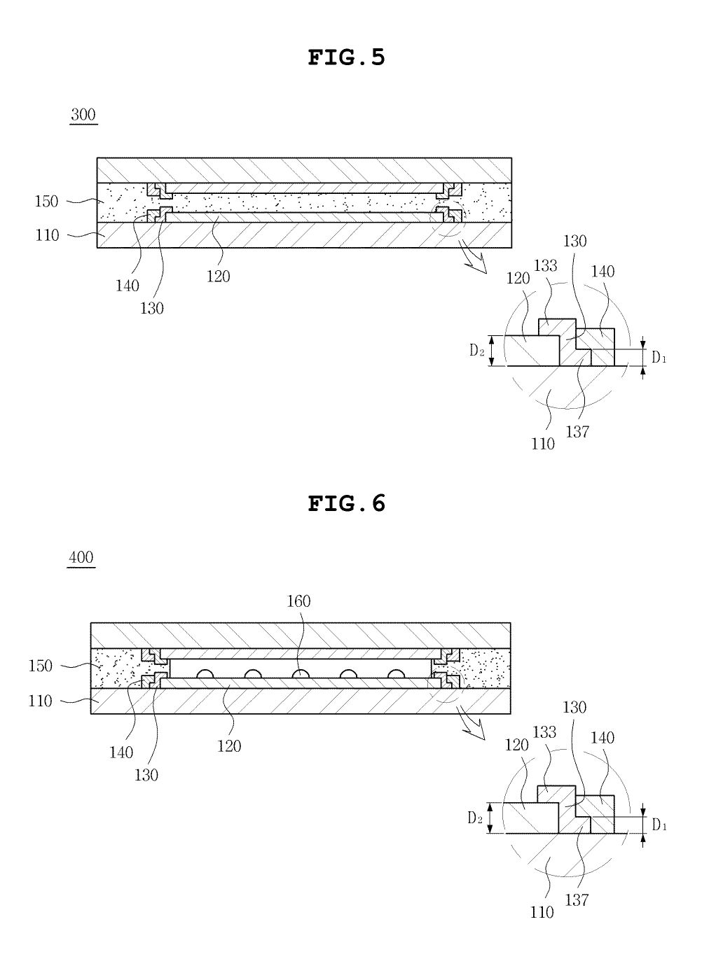

As shown in FIGS. 4 to 6, a mutual capacitive touch panel 200 (see FIG. 4) may be formed by forming transparent electrodes 120 on both surfaces of a transparent substrate 110, respectively. Besides, a mutual capacitive touch panel 300 (see FIG. 5) or a resistive touch panel 400 (see FIG. 6) may be manufactured by preparing two transparent substrates 110 having the transparent electrode 120 formed on one surface thereof and by bonding the two transparent substrates 110 through an adhesive layer 150 so that the transparent electrodes 120 are opposite to each other. Herein, in the case of the mutual capacitive touch panel 300 (see FIG. 5), the adhesive layer 150 is bonded to the entire surface of the transparent electrode 120 so that the two transparent electrodes 120 opposite to each other are insulated. In the case of the resistive touch panel 400 (see FIG. 6), the adhesive layer 150 is bonded to only the edge of the transparent electrode 120 so that the two transparent electrodes 120 opposite to each other can contact each other when a user applies pressure and a dot spacer 160 providing repulsive force is formed on the transparent electrode 120 so that the transparent electrode 120 is returned to its original position when the user removes pressure.

Meanwhile, as described above, a protective layer 130 is formed to have a “ [symbol] ” shape between the transparent electrode 120 and the electrode wiring 140, thereby making it possible to prevent the electromigration between the transparent electrode 120 and the electrode wiring 140, and the electrode wiring 140 is disposed at the side surface of the transparent electrode 120 rather than on the upper part of the transparent electrode 120, thereby making it possible to make the touch panels 200, 300, and 400 thin.

According to the present invention, the protective layer is interposed between the transparent electrode and the electrode wiring to prevent the electromigration (EM), thereby making it possible to prevent the performance of the touch panel from being degraded and the life span thereof from being shortened.

In addition, according to the present invention, the transparent electrode is connected to the electrode wiring through the protective layer to allow the electrode wiring to be disposed at the side surface of the transparent electrode, thereby making it possible to make the touch panel thin.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch panel, comprising:
a transparent electrode formed on one surface of a transparent substrate;
a protective layer formed at the side surface of the transparent electrode so that its upper end surrounds the edge of one surface of the transparent electrode and its lower end protrudes in the edge direction of the transparent substrate; and
an electrode wiring that is formed at the side surface of the protective layer so as to surround the lower end of the protective layer protruding in the edge direction of the transparent substrate.

2. The touch panel as set forth in claim 1, wherein the protective layer is made of gold (Au), platinum (Pt), carbons, or a mixture thereof.

3. The touch panel as set forth in claim 2, wherein the carbons include a carbon nano tube or a carbon nano fiber.

4. The touch panel as set forth in claim 1, wherein the transparent electrode is made of a conductive polymer.

5. The touch panel as set forth in claim 4, wherein the conductive polymer includes poly-3,4-ethylenedioxythiophene/polystyrenesulfonate (PEDOT/PSS), polyaniline, polyacetylene, or polyphenylenevinylene.

6. The touch panel as set forth in claim 1, wherein the height of the lower end of the protective layer protruding in the edge direction of the transparent substrate is lower than the height of the transparent electrode.
